(19) United States
(12) Patent Application Publication
(10) Pub. No.: US 2013/0028659 A1
(43) Pub. Date: Jan. 31, 2013

(54) APPARATUS AND METHOD FOR COHESIVE JOINING

(71) Applicants: Alois Leitner, Weyregg am Attersee (AT); Roland Rechberger, Steyregg (AT)

(72) Inventors: Alois Leitner, Weyregg am Attersee (AT); Roland Rechberger, Steyregg (AT)

(73) Assignee: VOESTALPINE STAHL GMBH, Linz (AT)

(21) Appl. No.: 13/640,611

(22) PCT Filed: Apr. 12, 2011
(86) PCT No.: PCT/AT11/00177

§ 371 Date: Oct. 11, 2012

(30) Foreign Application Priority Data
Apr. 12, 2010 (AT) A 587/2010
Apr. 21, 2010 (AT) A 657/2010

(51) Int. Cl. B23K 31/02; F16B 11/00; B23K 20/22; B23K 1/19

(52) U.S. Cl. 403/272; 228/256; 228/212; 228/33

(57) ABSTRACT

The invention relates to an apparatus and to a process for cohesively joining two plates (1 and 2) having differing melting points, one of which plates, the end plate (1), includes a light metal material, in particular aluminum material, and the other of which plates, the connecting plate (2), includes an iron and/or titanium material, wherein a coating (9) preferably on the basis of zinc or aluminum is provided at least partially on at least one of the abutting faces (3′, 3″) of the abutting edge (3) of the connecting plate (2) which extend inclined with respect to one another, in which process both plates (1 and 2) are joined together by braze welding so as to abut against one another along their common joint using an additional material (5) on the basis of light metal, in particular on the basis of aluminum. In order to provide advantageous process conditions, the invention proposes that a recess (10) be made, before joining, in the abutting edge (4) of the end plate (1) for receiving at least part of the coated abutting edge (3) of the connecting plate (2), wherein, during joining, braze welding is carried out at least partially over a flank (11 or 12) of the recess (10) overlapping the coating (9) of the connecting plate part.

### TECHNICAL FIELD

The invention relates to a method for cohesive joining of two metal sheets having a different melting point, of which the one sheet, the end sheet, exhibits a light metal material, particularly aluminum material, and the other, connecting sheet exhibits an iron and/or titanium material, wherein a coating, preferably on the basis of zinc or aluminum, is provided, at least in part, on at least one of the abutting surfaces of the abutting edge of the connecting sheet, which run at an incline relative to one another, in which method the two sheets are joined together by brazing, abutting one another, using an additional material on the basis of aluminum, along their common joint.

### STATE OF THE ART

In order to be able to join steel and aluminum sheets cohesively with one another, it is known from the prior art (WO2004030856A1 and WO2006012659A1) to provide a coating on a flattened join of abutting edge of the steel sheet, in order to thereby be able to apply the aluminum, which has melted as the result of a brazing process, to the steel sheet over an increased connection length. In the case of known brazing methods, in which the aluminum is melted and a solder connection forms on the steel side, the flattened abutting edge of the steel sheet is butted up against a blunt abutting edge of the aluminum sheet, and afterward, the two sheets are joined to one another by brazing, using an additional material. The deciding factors for the quality of the seam as well as the process reliability of the brazing method have now proven to be the connection length, the coating of the abutting edge, as well as, in this connection, the temperature of the joining region or the heat introduction into the joining region. Thus, on the one hand, the connection length is supposed to be long, in order to be able to expect the seam or the connection to withstand great stresses, which requires comparatively high temperatures for a broad joining region, but on the other hand, the temperature in the joining region is supposed to be low, in order to thereby counteract the growth of the phase seam composed of mixed metal compounds, in order to thereby not be forced to accept reduced strength. These criteria, which work against one another, therefore mostly lead to a compromise between process reliability and strength, and therefore great strength values generally cannot be achieved, particularly if thin sheets are supposed to be processed, in which case the temperature in the joining region requires particular attention.

Furthermore, the most varied tongue and groove profiling types are known from the prior art (EP0288884B1), which can be provided between two sheets composed of different materials. The grooves serve the purpose of being able to center the sheets relative to one another, in simple manner, or to not be forced to accept significant bending of the sheets that are abutting one another, in the region of the weld seam, if a cohesive connection is supposed to be created with a laser welding device. No teaching concerning a brazing method for joining of steel and aluminum sheets or for improvement of a connection between these sheets, which is difficult to produce, can be derived from EP0288884B1.

### PRESENTATION OF THE INVENTION

It is therefore the task of the invention, proceeding from the state of the art described initially, to create a brazing method with which great process reliability along with great connection strength can be achieved in simple manner. Furthermore, the method is supposed to be able to create a cohesive connection quickly.

The invention accomplishes the task in that before joining, a recess for accommodating at least a part of the coated abutting edge of the connecting sheet is introduced into the abutting edge of the end sheet, whereby during joining, brazing is carried out at least partially over a recess flank of the recess, which flank covers the coating of the connecting sheet part.

If a recess is introduced into the abutting edge of the end sheet, for accommodating at least a part of the coated abutting edge of the connection sheet, whereby during joining, brazing is carried out at least partially over a recess flank of the recess, which flank covers the coating of the connecting sheet part, then not only can simple positioning of the sheets relative to one another, as known from the state of the art, be made possible in this way, but also, the strength of a brazing connection between the sheets can be particularly improved in this way. This advantage specifically occurs not just as the result of engagement of the sheets into one another, but particularly by means of the protection of the coating of the connecting sheet during joining, because this coating is covered by the recess flank and thereby can be protected from the arc of the torch. For example, evaporation of the coating can be made more difficult in this manner, so that the joining region exhibits greater process reliability—despite a comparatively longer connection length between the sheets. Even high brazing speeds can therefore be made possible, because the coating can be protected from damage, for example caused by the introduction of heat or by plasma interactions of the welding arc of the torch. In particular, however, this “reciprocal engagement” of the sheets has proven to be advantageous with regard to reduction of the phase seam. By means of this arrangement, the temperature in the joining region can specifically be reduced because of an improved heat transition between the sheets, which can make comparatively great seam strength values possible even in the case of thin sheets. Therefore the method according to the invention is not only fast and reliable, but also can be used in many different ways and, at the same time, can create and guarantee great connection strengths even if steel sheets and aluminum sheets or sheets having an aluminum alloy are supposed to be firmly connected. In general, it is being mentioned that such a recess can be milled, cut, pressed, or even burned into a sheet, for example. V-shaped, U-shaped, semicircular-shaped recesses and those with a similar structure are possible. Furthermore, coatings in the form of foils on the connecting sheet are also possible.

If a recess is introduced into the end sheet in such a manner that its two recess flanks partially cover both abutting surfaces of the abutting edge of the connecting sheet during joining, then the coating can be protected on both abutting edge sides, in simple manner, against evaporation during joining. Furthermore, the two recess flanks can ensure an increased connection length, particularly since a reduced amount of solder material has to be introduced into the joining region during joining.

The solder material to be introduced can be further reduced if the recess is pressed into the abutting edge of the end sheet, because in this way, the light metal material, particularly aluminum material, in the joining region is not reduced in mass, as is known, for example, for milling methods. Furthermore, with this method, the occurrence of chips can be avoided, and therefore subsequent machining of the recess can also be eliminated.

Advantageous process conditions can result if the abutting edge of the end sheet is slit for the two recess flanks, and at least one of these recess flanks is bent open for the recess. Such bending open can be carried out after a cutting process, for example. Aside from the fact that the light metal material is not reduced in mass in the joining region, in this way at least a partially elastic accommodation, which can follow a contour of the abutting edge of the connecting sheet, can also be achieved in this way. In this way, a particularly intimate transition between the sheets can be created, and this can lead to advantageous process conditions.

If the abutting edge of the connecting sheet is pressed into the recess in order to at least partially widen this recess, then simplified process conditions for shaping of the recess can be created, because, for example, no particular attention needs to be paid to the configuration of the abutting edge of the connecting sheet. Specifically, an adaptation of the recess in accordance with the shape of the abutting edge can take place, so that even production tolerances cannot significantly influence the connection and also the process reliability, in simple manner. This is because the recess will always shape itself to lie against the connecting sheet, so that a special seam transition can also be ensured in simple manner.

If a wave-shaped progression is introduced into an abutting surface of the connecting sheet, then the strength that can be achieved by means of the brazing method can be further increased, because in addition to an extended connection length, different contact angles can also occur.

Constant process conditions can be achieved if the abutting sheets are clamped, for joining, into clamping jaws that can be cooled and are spaced apart from one another. In particular by means of cooling of the clamping jaws, their temperature can be kept constant during joining, so that reduced parameter changes during brazing can be expected.

Advantageous process conditions occur if brazing is carried out over both recess flanks at the same time, to create a common joining region. In this way, not only can the same welding parameters be set on both flank sides, thereby making a comparatively symmetrical configuration of the seam geometry possible, but also, the temperature in the joining region can be reduced, for increased strength values. Introduction of heat into the join on both sides specifically can ensure reduced heat loss in the joining region, as compared with introduction of heat from one side, so that in total, despite the process conditions being the same, a reduced phase seam can be expected, something by which the invention is particularly characterized. In addition, even comparatively thin sheets can be connected with one another, on the basis of a reduced temperature in the joining region.

The method according to the invention can advantageously be used to create a work piece, in that two sheets having different melting points, of which the one sheet, the end sheet, exhibits a light metal material, particularly aluminum material, and the other, connecting sheet exhibits an iron and/or titanium material, are cohesively joined. In general, it is being mentioned that the aluminum sheet can be produced from the most varied aluminum alloys. Use of the 5xxx, 6xxx, and 7xxx alloy series has proven to be advantageous. The steel sheet can particularly be a TRIP (transformation-induced plasticity), TWIP (twinning-induced plasticity), DP (dual phases) or CP (complex phases) steel, or can consist of another high-strength alloy. Furthermore, the use of a sheet exhibiting a light metal material, particularly aluminum material, has proven itself for a brazing method, which sheet has a recess having recess flanks that are bent open, for accommodating a coated abutting edge of an abutting connecting sheet. Specifically, not only can the coating be protected by means of such an accommodation, but also a special heat transition between the abutting sheets can be made possible, because the recess flanks can guarantee contact of the sheets, at least in certain regions.

Furthermore, it is the task of the invention to create a device that is simple in design, with which special process conditions for joining of sheets can be made possible.

The invention accomplishes the stated task in that at least two torches disposed on opposite sheet sides, in each instance, are directed at a common joining region of the joint, with their arcs.

If at least two torches disposed on opposite sheet sides, in each instance, are directed to a common joining region of the joint with their arcs, then uniform brazing conditions can be ensured in the joining region, in simple manner, in terms of design, thereby making it possible to achieve a comparatively great connection strength.

This connection strength can be further increased if the arcs are directed at the recess flanks of the end sheet.

### BRIEF DESCRIPTION OF THE DRAWING

In the figures, the object of the invention is shown as an example, using multiple exemplary embodiments. The drawings show:

FIG. 1 a representation of a joint to be joined, according to the state of the art,

FIG. 2 a representation of a joint according to the invention, for the method for joining according to the invention,

FIG. 3 a joint changed as compared with FIG. 2,

FIG. 4 another alternative configuration of the joint shown according to FIGS. 2 and 3,

FIGS. 5a and 5b a device for implementation of the method according to the invention,

FIG. 6 a schematic sectional view of a brazing connection, and

FIGS. 7 and 8 sectional views of brazing connections according to two exemplary embodiments.

### WAY OF IMPLEMENTING THE INVENTION

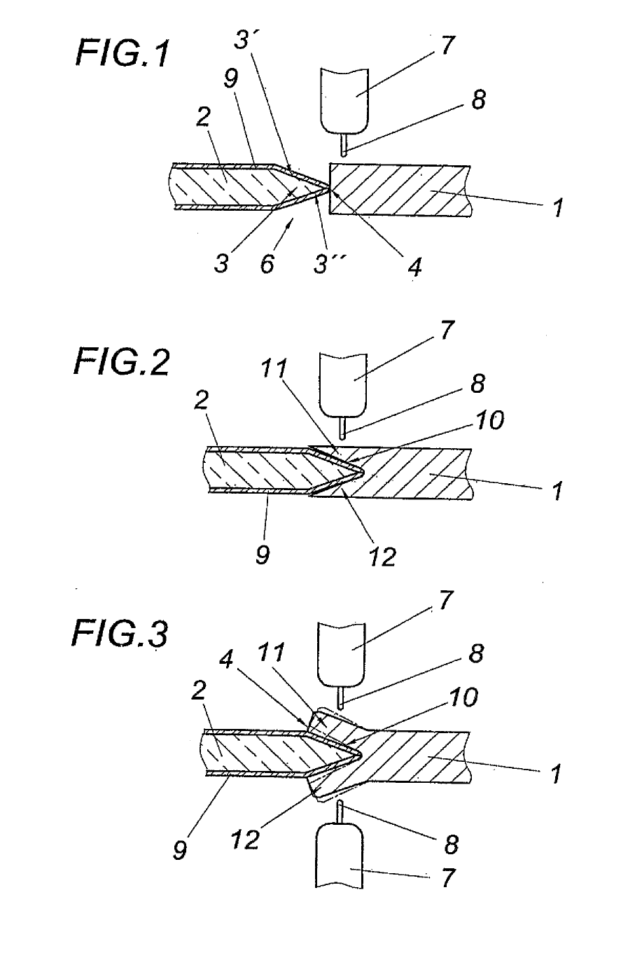

The known method for cohesive joining of two sheets 1 and 2 having a different melting point, in each instance, is shown according to FIG. 1. Thus, the end sheet 1 exhibits an aluminum material or an aluminum alloy, and the connecting sheet 2 exhibits a steel material. In known manner, a flattened abutting edge 3 is provided on the connecting sheet 2, which edge forms abutting surfaces 3′ and 3″ inclined relative to one another, namely running toward one another in V shape. The abutting edge 3 abuts the end sheet 1, specifically at its blunt abutting edge 4. During joining of the sheets 1 and 2 that abut one another, is now introduced into this joining region 6, using an additional material 5 that is merely indicated in FIG. 6, in which the mass in the joining region 6 is increased after the brazing process, which is made possible by the welding device 7. This welding device 7 now creates a cohesive connection, using a brazing method, between the sheets 1 and 2 that abut one another, as shown in FIG. 1. In general, it is being mentioned here that the sheets 1, 2 do not necessarily have to exhibit straight-line edges, following the most varied contour progressions. Also, the abutting edge 3 of the connection sheet 2 does not need to be continuously present, whereby the end sheet 1 can exhibit over regions on its abutting edge 4 that do not exhibit a recess.

It has now turned out that the connection between the sheets 1 and 2 can be negatively influenced not only due to an increased introduction of connection material or additional material 5, but also, it has proven to be problematic, in connection with brazing, that a coating 9 of the connecting sheet 2 can be damaged by the arc 8 of the welding device 7. However, this coating 9 is particularly important for implementability and process reliability of the brazing method, particularly because wetting of the connecting sheet 2 with material of the end sheet 1 and/or of the additional material 5 is functionally ensured with it. These difficulties are particularly decisive for the role of the cohesive connection in the case of long connection lengths between the sheets 1 and 2 that are required, and in the case of thin sheets 1 and 2.

According to the invention, the brazing method is improved in that a recess 10 is introduced into the end sheet 1, in such a manner that this recess can accommodate at least parts of the coated abutting edge 3 of the connecting sheet 2, as can be derived from FIG. 2. If, furthermore, during joining, brazing is now carried out at least partially over a recess flank 11 of the recess 10, which flank covers the coating 9 of the connecting sheet part, then the coating 9 can be protected from the arc 8 of the welding device 7, at least from direct impact. The recess flank 11 that lies above it therefore protects this coating 9, which acts as a wetting layer, thereby making it possible to not only ensure an increased connection length between end sheet 1 and connecting sheet 2, but also to guarantee a particularly reliable brazing method.

The two recess flanks 11 and 12 partially cover the two abutting surfaces 3′, 3″ of the flattened abutting edge 3 of the connecting sheet 2, which can advantageously reduce evaporation of the wetting layer on the abutting edge 3″ of the connecting sheet 2 that faces away from the arc 8. In this region, too, increased process reliability, with a comparatively firm brazing connection, can therefore be expected.

The recess 10 can be produced in simple manner, if the end sheet 1 is slit open along its face, for example by means of a cutting or pressing method, and then bent open in V shape. Furthermore, the solder consumption can be reduced in this way, because the material of the end sheet 1 is available to the joining region 6 without removal of chips, as can be seen in FIG. 3, as an alternative embodiment of the recess 10. Here, the recess flanks 11 and 12 are shown bent open.

Among other things, however, special process conditions for positioning of the sheets 1 and 2 can result from this, because the recess flanks 11 and 12 can have a centering effect. Furthermore, these can certainly ensure a seamless transition in the joining region, by means of their elastic properties, which can lead to an improved cohesive connection, in that when the connecting sheet 2 is pressed into the V-shaped recess 10, this recess 10 widens, at least in part, because widening possibilities have been indicated with a dot-dash line. Furthermore, heat introduction with a welding device 7, in each instance, is carried out from both sides of the recess flanks 11 and 12, in order not only to use the coating 9 on the two abutting surfaces 3′, 3″ at the same time during joining, but also to be able to prevent its evaporation, which evaporation can occur disadvantageously in the case of one-sided heat introduction from the state of the art, and thereby the process reliability can also be increased.

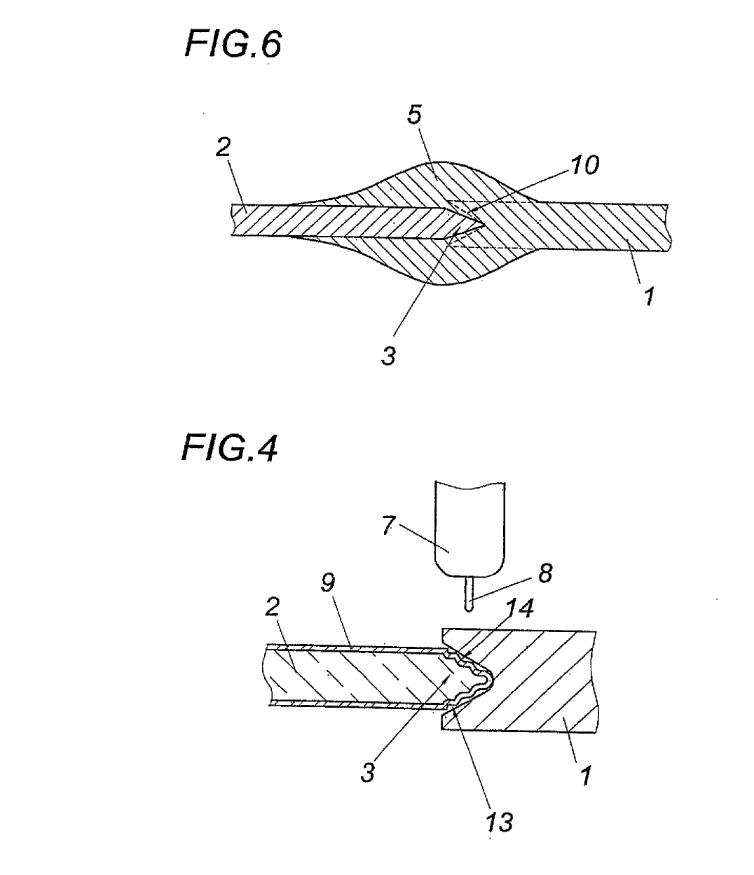

According to FIG. 4, a special progression of the abutting edge 3 of the connecting sheet 2 is furthermore shown, as compared with the embodiments according to FIGS. 2 and 3. The abutting surfaces 13 and 14, along with the coating 9 provided on them, run toward one another in wave shape. In this way, an increased connection length between the sheets 1 and 2 can advantageously be produced, whereby almost any connection angle can be produced by means of the wave-shaped progression, which can be a crown, for example, in order to thereby increase the strength of the brazing connection.

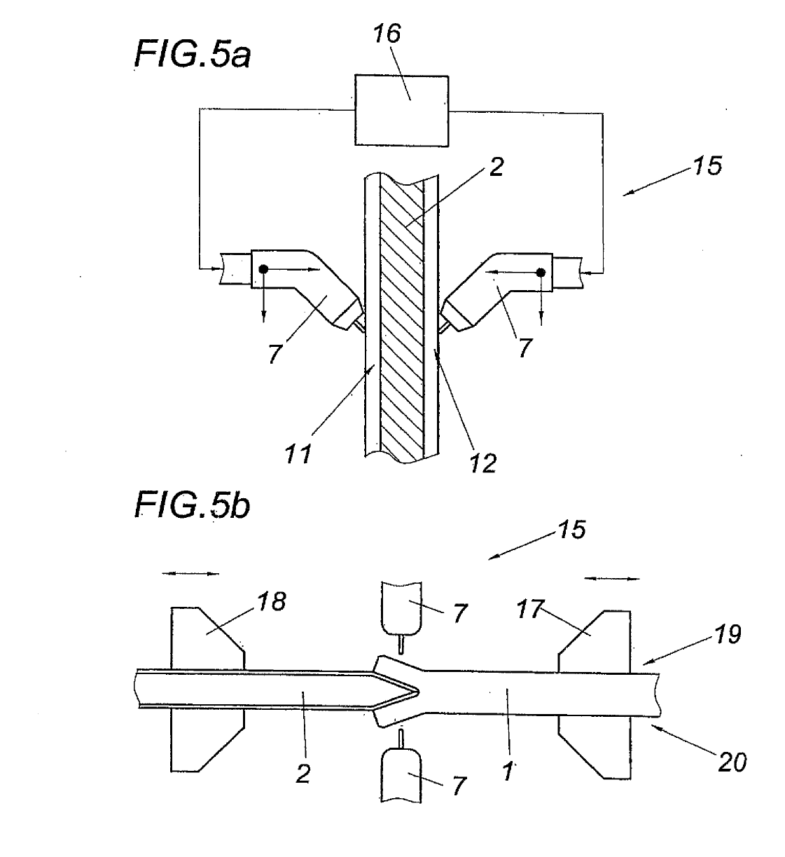

An apparatus 15 for carrying out the method is shown in a simplified representation, according to FIGS. 5a and 5b. The side view according to FIG. 5a shows two torches 7 that are guided along the joint of the two sheets 1 and 2. For this purpose, the torches 7 are guided on movement axes, which have been shown only schematically, by way of a control device 16. Two clamping jaws 17 and 18, which are structured as holders, are movable and can also be cooled, clamp the sheets 1 and 2 in place, and are used for aligning and abutting the sheets 1 and 2 relative to one another. As has already been mentioned, cohesive joining of the two sheets 1 and 2 is produced using an arc 8 of the torch 7, whereby in order to achieve particularly ideal process conditions, at least two torches 7, disposed on opposite sheet sides 19 and 20, in each instance, are directed at a common joining region 6 of the joint with their arcs 8.

For this apparatus 15 and the method according to the invention, steel sheets having a thickness of 0.5 to 3 mm, preferably 0.6 to 2 mm, preferentially 0.7 to 1.5 mm, and aluminum sheets having a thickness of 1 to 5 mm, preferably 1 to 3 mm, preferentially 1 to 2.5 mm, have proven to be advantageous. Furthermore, it was possible to achieve a seam formation of 60 to 300 cm per minute with the apparatus 15 shown, without having to accept losses in the connection strength with this. Likewise, however, even thicker sheets having a thickness of 10 to 20 mm can be connected using the method described, without problems. Furthermore, using the method according to the invention, it is possible to advantageously reduce height differences caused by different sheet thicknesses, whereby in this way, the strength can also additionally increase by means of an increase in the connection surface area. Furthermore, brazing does not necessarily need to take place synchronously from both sides, in the case of thick sheets, but rather each side can be brazed on its own. This is because the increased sheet thickness of the connecting sheet or steel sheet can advantageously prevent the risk of evaporation of the coating. In addition, in the case of comparatively thick sheets, a reduced feed of an additional material can occur.

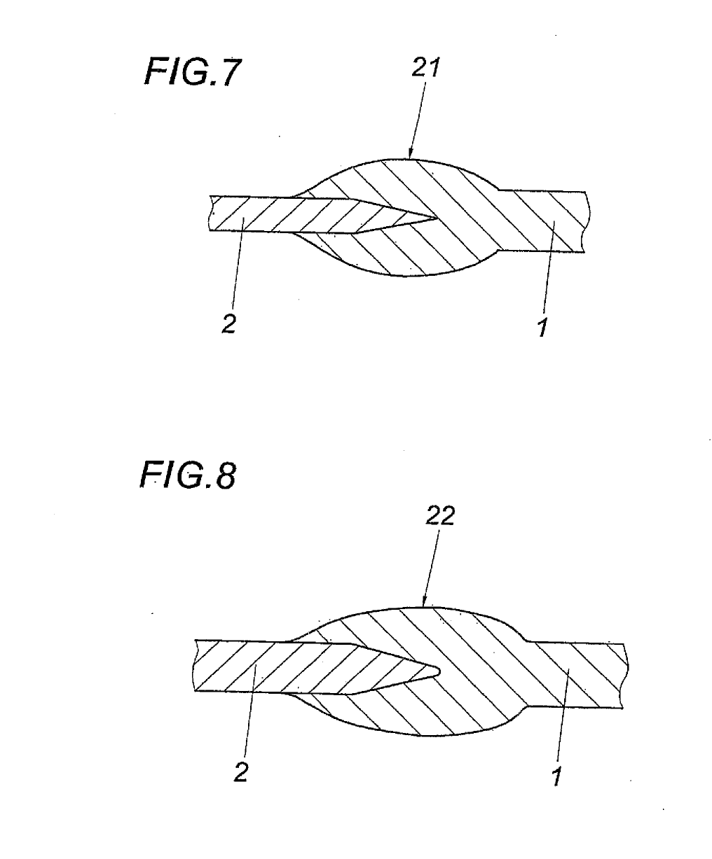

As an example, a brazing connection 21 between a steel sheet, grade DX54+Z140, having a thickness of 1 mm, structured as a connecting sheet 2, and an aluminum sheet, grade AW6016, having a sheet thickness of 1.2 mm, structured as an end sheet 1, is now shown according FIG. 7. According to the invention, a yield strength Rp0.2 of 132 MPa and a tensile strength Rm of 239 MPa (with reference to the aluminum cross-section, in each instance) can be made possible with this.

The brazing connection 22 shown according to FIG. 8 is provided between a steel sheet, grade DX54+Z140, having a thickness of 1.2 mm, structured as a connecting sheet 2, and an aluminum sheet, grade AW6181, having a sheet thickness of 1.5 mm, structured as an end sheet 1. Here, yield strength Rp0.2 of 126 MPa and a tensile strength Rm of 210 MPa (with reference to the aluminum cross-section, in each instance) could be made possible.

1. Method for cohesive joining of two metal sheets having a different melting point, of which the one sheet, the end sheet, exhibits a light metal material, particularly aluminum material, and the other, connecting sheet exhibits an iron and/or titanium material, wherein a coating, preferably on the basis of zinc or aluminum, is provided, at least in part, on at least one of the abutting surfaces of the abutting edge of the connecting sheet, which run at an incline relative to one another, in which method the two sheets are joined together by brazing, abutting one another, using an additional material on the basis of a light metal, particularly on the basis of aluminum, along their common joint, wherein before joining, a recess (10) for accommodating at least a part of the coated abutting edge (3) of the connecting sheet (2) is introduced into the abutting edge (4) of the end sheet (1), wherein during joining, brazing is carried out at least partially over a recess flank (11 or 12, respectively) of the recess (10), which flank covers the coating (9) of the connecting sheet part.

2. Method according to claim 1, wherein a recess (10) is introduced into the end sheet (1) in such a manner that its two recess flanks (11 and 12) partially cover both abutting surfaces (3′, 3″) of the abutting edge (3) of the connecting sheet (2) during joining.

3. Method according to claim 1, wherein the recess (10) is pressed into the abutting edge of the end sheet (1).

4. Method according to claim 1, wherein the abutting edge (4) of the end sheet (1) is slit for the two recess flanks (11 and 12), and at least one of these recess flanks (11 and 12) is bent open for the recess (10).

5. Method according to claim 3, wherein the abutting edge (3) of the connecting sheet (2) is pressed into the recess (10), which is particularly V-shaped, in order to at least partially widen this recess (10).

6. Method according to claim 1, wherein a wave-shaped progression is introduced into an abutting surface (13, 14) of the connecting sheet (2).

7. Method according to claim 1, wherein for joining, the abutting sheets (1 and 2) are clamped into clamping jaws (17, 18) that can be cooled and are spaced apart from one another.

8. Method according to claim 1, wherein brazing is carried out over both recess flanks (11 and 12) at the same time, for creation of a common joining region (6).

9. Work piece having sheets (1 and 2) having two different melting points, of which the one sheet, the end sheet (1), exhibits a light metal material, particularly aluminum material, and the other, connecting sheet (2) exhibits an iron and/or titanium material, wherein the two sheets (1 and 2) are cohesively joined by means of a method according to claim 1.

10. Use of a sheet (1), exhibiting a light metal material, particularly aluminum material, having a recess (10) having recess flanks (11 and 12) that are bent open, for accommodating an abutting edge of an abutting connecting sheet (2), for a brazing method.

11. Apparatus for implementation of the method according to claim 8, having holders, particularly clamping jaws (17, 18) that accommodate the sheets (1, 2), in each instance, for aligning and abutting the sheets (1, 2) relative to one another, and having at least one burner (7) having an arc (8), for cohesive joining of the two sheets (1 and 2), wherein at least two torches (7) disposed on opposite sheet sides (19, 20), in each instance, are directed at a common joining region (6) of the joint with their arcs (8).

12. Apparatus according to claim 11, wherein the arcs (8) are directed at the recess flanks (11, 12) of the end sheet (1).
